(19) United States
(12) Patent Application Publication
(10) Pub. No.: US 2021/0197356 A1
(43) Pub. Date: Jul. 1, 2021

(54) ELECTRICAL TOOL

(71) Applicant: TECHWAY INDUSTRIAL CO., LTD., Taichung City (TW)

(72) Inventors: Fu-Hsiang CHUNG, Taichung City (TW); Sai I HUANG, Taichung City (TW); Min Chien TSAI, Taichung City (TW)

(21) Appl. No.: 17/098,390

(22) Filed: Nov. 15, 2020

(30) Foreign Application Priority Data
Dec. 30, 2019 (TW) 108148450
Dec. 30, 2019 (TW) 108148451

(51) Int. Cl. B25F 5/00

(52) U.S. Cl. CPC B25F 5/008; B25D 17/04

(57) ABSTRACT

The invention relates to an electrical tool comprising: a straight assembly line formed between front and rear ends of the electrical tool; a casing with a transmission assembly and a drive assembly disposed along the assembly line inside the casing; a battery unit; and a handle disposed at a rear end of the casing along the assembly line; the electrical tool of the invention is capable of disposing the integral components along the same assembly line so that a center of gravity of the electrical tool will be close to the assembly line, thereby capable of reducing a lateral acting force when the electrical tool is held or operated.

### BACKGROUND OF THE INVENTION

### Field of the Invention

The invention relates to electrical tools, and more particularly to an electrical tool in which components are disposed along a straight line, and center of gravity is close to a center of the electrical tool for convenience of operating and holding.

### Description of the Related Art

FIG. 1 shows a conventional electrical tool 10 comprising a body 11 and a head 12, a front end of the body 11 connected with the head 12, so that the head 12 can be driven by the body 11 to move, an extension 13 is provided below the body 11 for placement of a motor and a battery, and an operating handle 14 is provided behind the body 11 and the extension 13; during operation, a user will hold the operating handle 14 and the head 12 respectively with both hands.

However, in the above-mentioned prior art, due to design restrictions, the body 11 and the extension 13 are disposed on different lines. The operating handle 14 is disposed behind the body 11 and the extension 13, which cannot provide a protective effect for the body 11 and the extension 13. If the electrical tool 10 falls or is impacted by an external force, the battery installed in the extension 13 may be separated from the body 11 and needs to be reinstalled before the electrical tool 10 can be used again. In addition, because disposition of the extension 13 is deviated far from a center of the body 11 and the head 12, a weight of the extension 13 will form a moment of force due to the deviation of its position. When operating or holding the electrical tool 10, in addition to a weight of the electrical tool 10 itself, the user also needs to overcome a moment of force and a lateral acting force generated by the weight deviation. Therefore, using the electrical tool 10 for a long period of time will make the user's hands feeling discomfort. In order to increase the endurance or meet the operating moment of force, a weight of the battery or motor in the extension 13 will be increased relatively, which will cause a center of gravity position to deviate from an axis of the head 12 too much. During operation, a moment of force will exceed the weight of the electrical tool 10 itself, causing the user to bear the moment of force in addition to the weight of the electrical tool 10 when operating the electrical tool 10.

Since the body 11 and the extension 13 are not on a same straight line, overall contour sizes and cross-sectional areas of the body 11 and the extension 13 increases, and thus an operating field or a storage space of the electrical tool 10 will be affected, causing the electrical tool 10 to be incapable of operating in a narrow space or a larger space for storage to be required.

In addition, since the body 11 and the extension 13 are not disposed on a same straight line, and the components in the body 11 and the extension 13, such as motor, circuit unit, and battery, will generate heat during operation; when the electrical tool 10 guides external air to enter the interior to dissipate heat, only part of the air flows through specific positions of the electrical tool 10, which makes the heat dissipation effect poor, and cannot produce heat dissipation effect throughout the electrical tool 10. As a result, heat cannot be removed, excessive heat accumulated inside the electrical tool 10 can easily cause malfunction or poor operating efficiency, and ultimately reduce a service life of the electrical tool 10.

### SUMMARY OF THE INVENTION

A main objective of the invention is to provide an electrical tool with components disposed along a straight line to cause an overall center of gravity of the electrical tool to be close to a center of the electrical tool, so that it is easier and more labor-saving to move or operate the electrical tool.

Another objective of the invention is to provide an electrical tool with a relatively simple contour to be capable of operating and being stored in a narrow space.

Yet another objective of the invention is to provide an electrical tool, with better heat dissipation effect, capable of providing a straight heat dissipation channel for the electrical tool, improving the service life of the electrical tool.

In order to achieve the above-mentioned objectives, the invention provides an electrical tool, comprising:

an assembly line defined between a front end and a rear end of the electrical tool, being a straight line;

a casing;

a transmission assembly and a drive assembly disposed inside the casing along the assembly line; the transmission assembly being disposed in front of the drive assembly, the drive assembly being capable of driving the transmission assembly to actuate;

a battery unit disposed at a rear end of the casing, the battery unit being electrically connected with the drive assembly; and

a handle disposed at the rear end of the casing.

Preferably, a receiving space is formed between the handle and the casing; the battery unit is disposed between the receiving space.

Preferably, the receiving space is located at a central position of the handle, and shapes of the handle on both sides of the receiving space are symmetrical.

Preferably, the casing has a front casing and a rear casing, the transmission assembly is disposed inside the front casing, the drive assembly is disposed inside the rear casing; the front casing and the rear casing are assembled and disposed along the straight assembly line.

Preferably, two sides of the casing form a width of the casing, and a casing maximum width is formed at a position with a largest width of the casing; a handle width is formed between two sides of the handle; a ratio of the handle width to the casing maximum width is between 1-1.5.

In the electrical tool provided by the invention, the drive assembly and the transmission assembly inside the casing and the external handle and the battery unit are linearly arranged along the same assembly line, so that a center of gravity of the electrical tool will be close to the assembly line, thereby the electrical tool as a whole can be operated and held easily, moment of force and lateral acting force will not be generated otherwise caused by deviation of center of gravity, and discomfort of use can be reduced.

### BRIEF DESCRIPTION OF THE DRAWINGS

In order to enable the examiner to further understand the objectives, features, and achieved efficacies of the invention, three preferred embodiments are listed below for detailed explanation in conjunction with the drawings, wherein:

FIG. 1 is a schematic diagram of a conventional electrical tool;

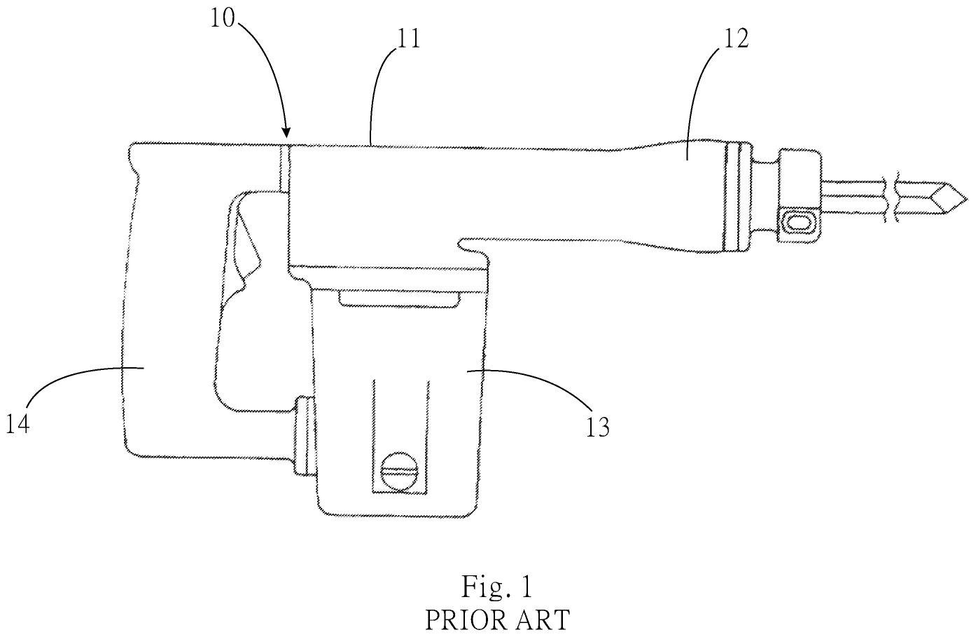

FIG. 2 is a perspective view of an electrical tool according to a preferred embodiment of the invention;

FIG. 3 is a side view of FIG. 2;

FIG. 4 is a partial cross-sectional view of FIG. 2;

FIG. 5 is an exploded perspective view of a handle separated from a casing of FIG. 2;

FIG. 6 is a partially enlarged perspective exploded view of the handle and part of the casing of FIG. 4;

FIG. 7 is a partially enlarged perspective exploded view of part of the casing and a battery unit of the electrical tool;

FIG. 8 is a cross-sectional view of assembly between the handle and the casing of the electrical tool;

FIG. 9 is a perspective view of the electrical tool with a side where a front handle is not installed;

FIG. 10 is a front cross-sectional view of the electrical tool;

FIG. 11 is a perspective view of the front handle of the electrical tool being installed at a different position;

FIG. 12 is a partial sectional schematic view of the electrical tool with air flow directions;

FIG. 13 is a perspective view of the electrical tool with overall air flow directions;

FIG. 14 is a schematic diagram of operation of the electrical tool;

FIG. 15 is another schematic diagram of operation of the electrical tool;

FIG. 16 is a partial sectional schematic view of a second preferred embodiment of the electrical tool with air flow directions;

FIG. 17 is a perspective view of a second preferred embodiment of the electrical tool with overall air flow directions;

FIG. 18 is an exploded perspective view of the handle separated from the casing according to a third preferred embodiment of the electrical tool;

FIG. 19 is a front cross-sectional view of the third preferred embodiment of the electrical tool; and

FIG. 20 is a partial-sectional schematic view of the third preferred embodiment of the electrical tool with air flow directions.

### DETAILED DESCRIPTION OF THE INVENTION

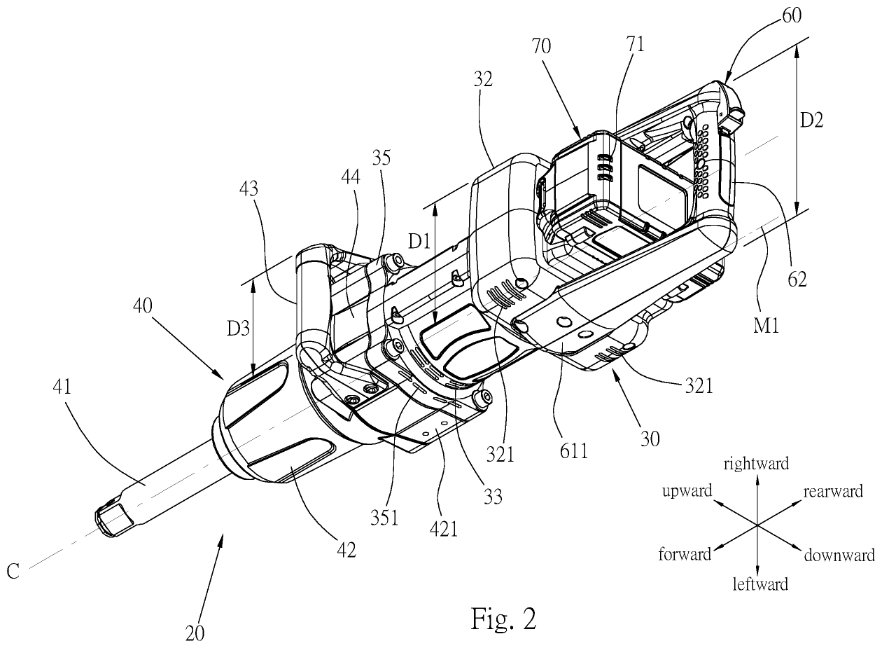

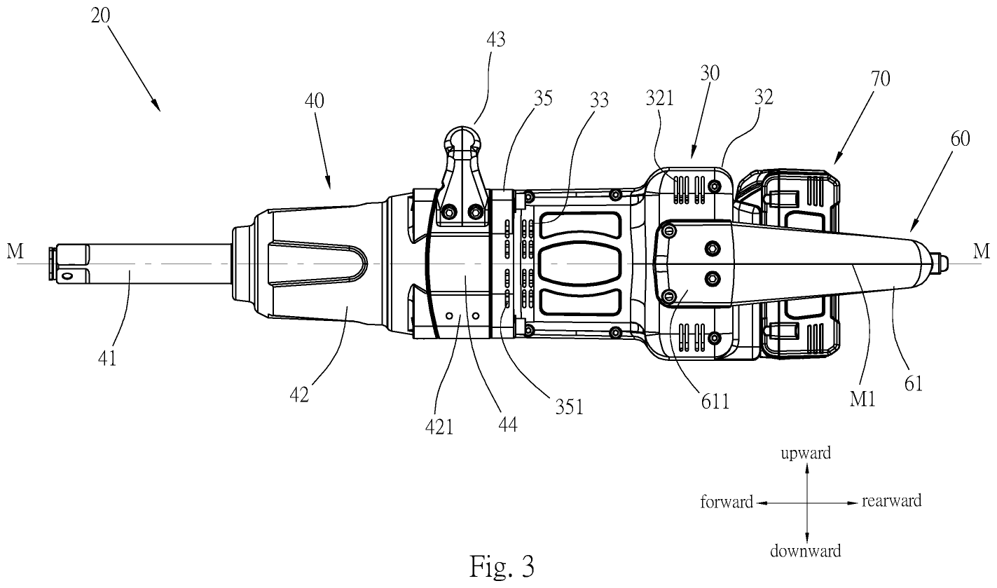

Please refer to FIGS. 2 to 5 for an electrical tool 20 provided by a preferred embodiment of the invention. In FIG. 2, vertical upward direction in the figure is indicated as upward direction, and vertical downward direction is indicated as downward direction. In addition, horizontal left direction in a direction from a rear end to a front end in FIG. 2 is indicated as left, and horizontal right direction is indicated as right. And, directions after FIG. 3 correspond to FIG. 2 as indications, but the directions are for illustration only and not restrictions in use. The electrical tool 20 is formed with a straight assembly line C between front and rear ends. The electrical tool 20 includes a casing which is arranged along the assembly line C. In addition, please refer to FIG. 3, the casing of the electrical tool 20 is defined with a central bisector M, which is located at a center of the casing of the electrical tool 20. The electrical tool 20 forms an upper half configuration and a lower half configuration at upper and lower sides of the central bisector M, respectively. The upper half configuration and the lower half configuration are symmetrically disposed on the central bisector M at upper and lower sides. Inside the casing is provided with a transmission assembly 40 and a drive assembly 50, and the transmission assembly 40 and the drive assembly 50 are disposed in a straight line along the assembly line C. The casing has a width between left and right sides thereof, a casing maximum width D1 is formed at a position with a largest width of the casing, and a handle 60 formed in an annular configuration is connected behind the casing. The handle 60 has a handle width D2, the handle width D2 is slightly larger than the casing maximum width D1, and a battery unit 70 is disposed behind the casing and at an inner side the handle 60. An overall arrangement of the electrical tool 20 is disposed in a straight line along the assembly line C, and centers of gravity of the casing, the transmission assembly 40, the drive assembly 50, the handle 60, and the battery unit 70 are set as close as possible to the assembly line C, so that a center of gravity of the electrical tool 20 can be located close to a center, which can reduce an excessively large arm of force formed because a center of gravity is deviated too much, thereby reducing the generation of moment of force, linear arrangement along the assembly line C can reduce an overall contour size and cross-sectional area, and the handle width D2 of the handle 60 being only slightly larger than the casing maximum width D1 makes it possible to operate in a narrow position and occupy a smaller storage space. In addition, the handle 60 can produce a peripheral protection effect for the battery unit 70, which can prevent the battery unit 70 from being subjected to external impacting forces to cause damage or separation.

The casing includes a front casing 42 and a rear casing 30, which are arranged along the assembly line C, and the front casing 42 and the rear casing 30 are respectively formed in upper and lower symmetrical configurations along the central bisector M, so that the electrical tool 20 can form an overall contour with upper and lower symmetrical arrangement, and centers of gravity of the front casing 42 and the rear casing 30 can be close to the assembly line C. The front casing 42 in this embodiment has front and rear two-section assembly modules, the rear casing 30 has upper and lower two-section assembly modules, and its design can be changed according to processing method, part layout and other requirements, and is not limited to a quantity of modules and assembly locations of the front casing 42 and the rear casing 30.

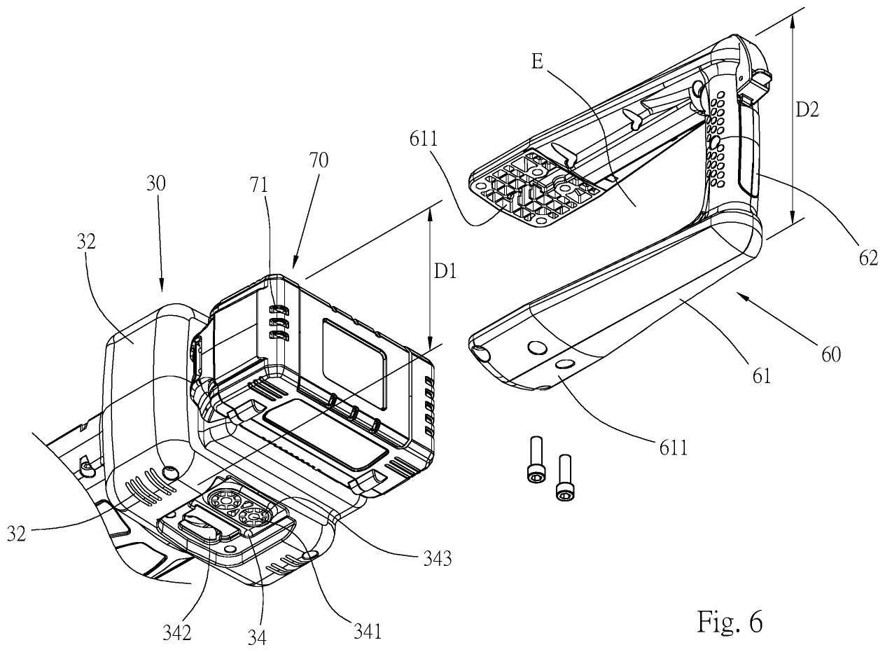

An accommodating space 31 is formed inside the rear casing 30. Front and rear ends of the rear casing 30 and front and rear ends of the accommodating space 31 are all located on the assembly line C, and the casing maximum width D1 is located at a rear side of the rear casing 30 and is formed as an assembly section 32. A width of the assembly section 32 is greater than or equal to the entire casing maximum width D1, that is to say, an entire width of the casing may be set to be equal to or less than the casing maximum width D1. The rear casing 30 is provided with a plurality of rear vents 321 and a plurality of front vents 33, the rear vents 321 and the front vents 33 communicate with the accommodating space 31. Arrangement positions and opening sizes and shapes of the rear vents 321 and the front vents 33 can be designed to achieve a better fluid flow effect, but it is not limited thereto. The rear vents 321 are disposed at positions of the assembly section 32. Please refer to FIG. 6, centers of left and right sides of the assembly section 32 at the rear end of the rear casing 30 are respectively recessed with an assembly portion 34 inwardly, so that the assembly portion 34 is slightly lower than the assembly section 32. The assembly portion 34 can also be disposed at a position with less width of the rear casing 30, and the design of position is not limited thereto. The two assembly portions 34 are respectively provided with two screw holes 341 and an auxiliary rear vent 342. The auxiliary rear vents 342 communicate with the accommodating space 31. A circumference of each of the two screw holes 341 is convexly provided with reinforcing ribs 343, the reinforcing ribs 343 form an outwardly radiating configuration along a periphery of each of the two screw holes 341, and a ring is surroundingly provided at an outermost side. A configuration of the reinforcing rib 343 can also be changed according to design without limiting its configuration. Furthermore, the front end of the rear casing 30 is provided with a connecting portion 35, an outer circumference of the connecting portion 35 is provided with a connecting vent 351, the connecting vent 351 communicates with the accommodating space 31, and arrangement position and opening size and shape of the connecting vent 351 can be designed to achieve a better fluid flow effect, but it is not limited thereto. The rear end of the rear casing 30 is provided with a joint 36, a joint vent 361 is formed through the joint 36, and the joint vent 361 also communicates with the accommodating space 31.

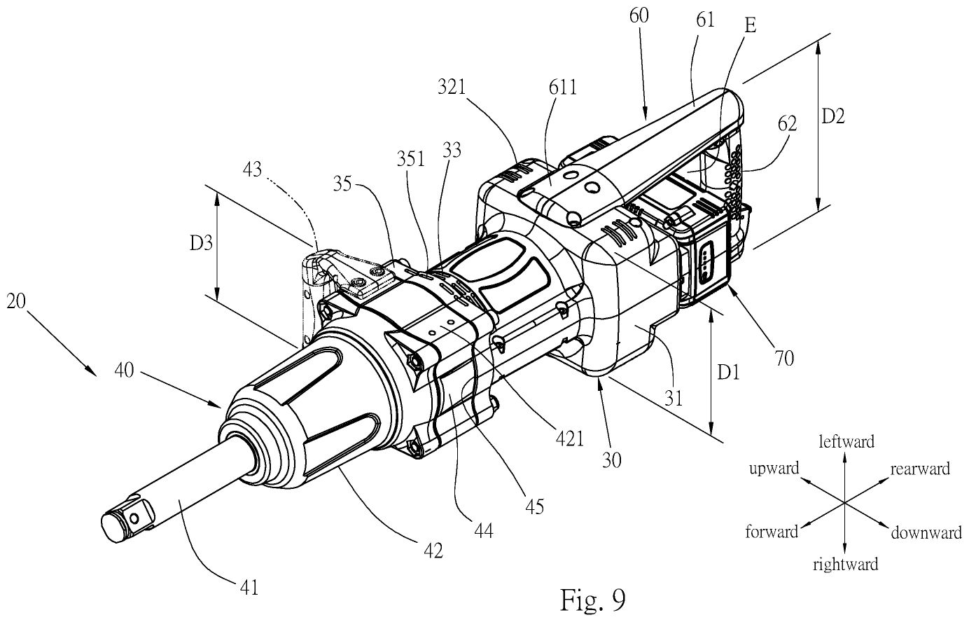

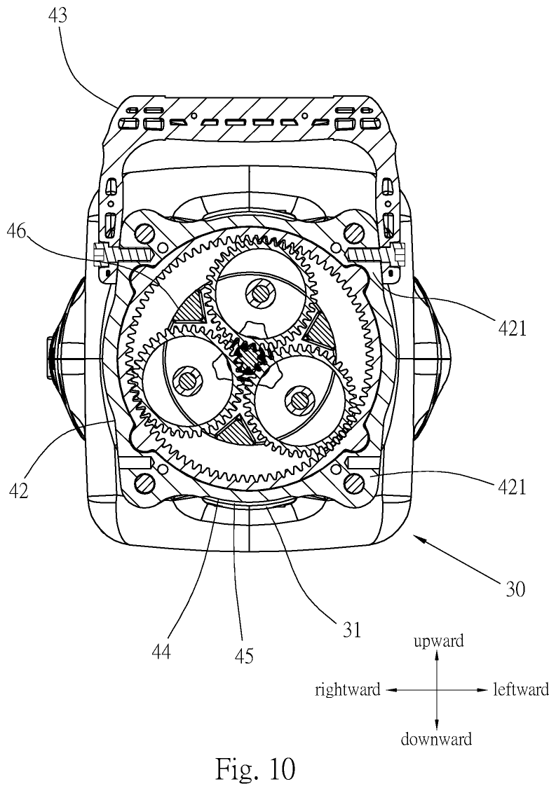

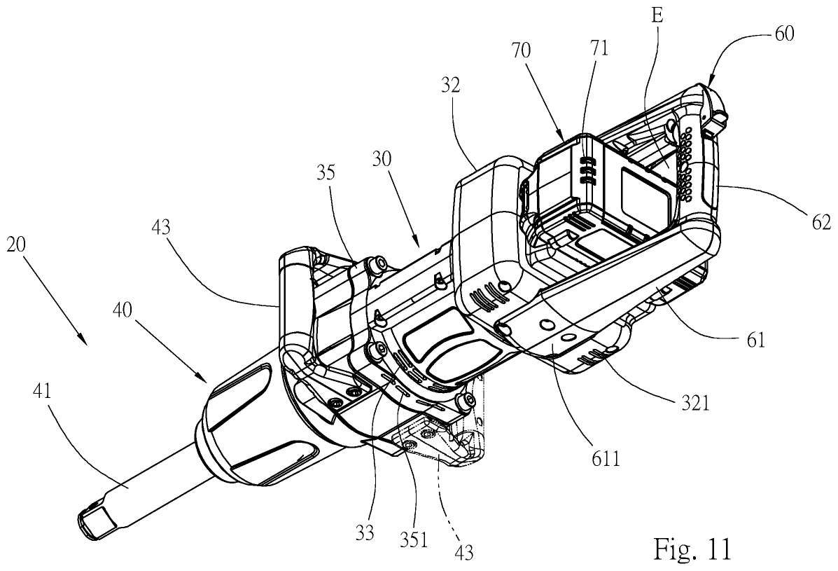

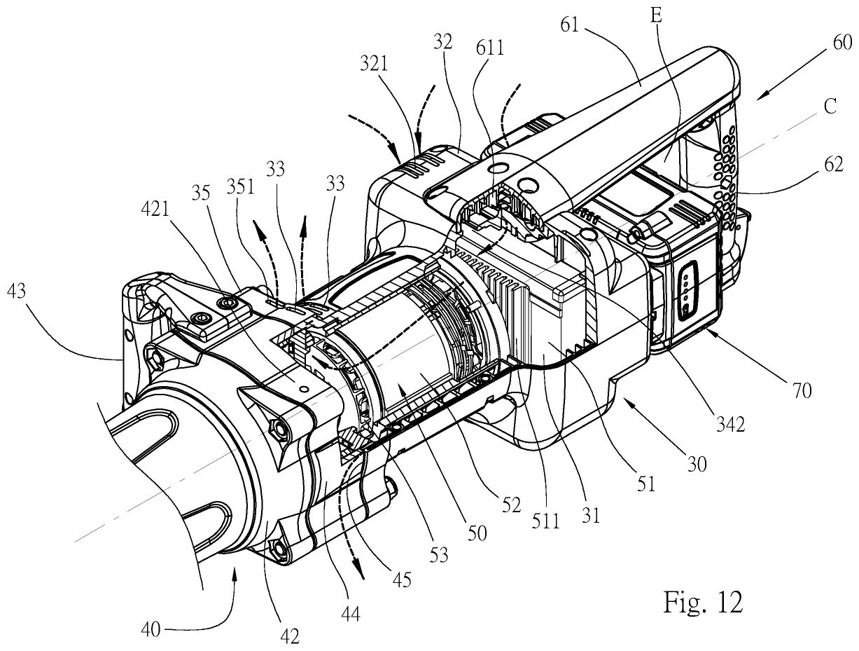

The transmission assembly 40 is sleeved inside the front casing 42 and located at the front end of the rear casing 30. Please refer to FIGS. 9 and 10, front and rear ends of the front casing 42 are located on the assembly line C. The transmission assembly 40 is provided with a transmission device 46 and an acting shaft 41 inside the front casing 42. The acting shaft 41 is provided at a front end of the transmission assembly 40 and protrudes outside of the front casing 42. The acting shaft 41 is driven by the transmission device 46, the transmission device 46 and the acting shaft 41 are disposed along the assembly line C, centers of gravity of the transmission device 46 and the acting shaft 41 are set close to the assembly line C, so that a center of gravity of the transmission assembly 40 is close to the assembly line C. In this embodiment, the transmission device 46 can be a reduction gear set and can drive the acting shaft 41, this part is a conventional actuating structure, and thus will not be repeated here. The front casing 42 is formed with a link portion 421 on upper and lower sides respectively; please refer to FIG. 11, a front handle 43 can be selectively assembled on the upper link portion 421 or the lower link portion 421 according to requirements to facilitate holding, using and changing hand by users with different dominant hands. When a weight of the electrical tool 20 is light, such as less than 3 kg, the electrical tool 20 can be operated with one hand, and the front handle 43 is not required. When a weight of the electrical tool 20 is more than 5 kg, it is necessary to hold the front handle 43 to disperse a force of operation and holding to overcome a lateral acting force generated by rotation of the electrical tool 20. Especially if a weight of the electrical tool 20 is more than 8 KG, lateral acting force of rotation will be even greater, the front handle 43 and the handle 60 must be held with both hands at the same time. When a weight of the electrical tool 20 exceeds 8 KG, and a user needs to fetch or move the electrical tool 20, if a center of gravity of the electrical tool 20 is not coaxially set, it is easy to cause deviation of applied force during moving, and it is not easy to apply force. A front handle width D3 is formed between left and right sides of the front handle 43. The front handle width D3 is less than or equal to the handle width D2. Please refer to FIG. 12, the front casing 42 of the transmission assembly 40 is recessed with two grooves 44 at the rear end. The grooves 44 are inclined from front to back inwardly. The rear end of the front casing 42 of the transmission assembly 40 is assembled with a front end of the connecting portion 35 of the rear casing 30. An auxiliary front vent 45 is formed between the accommodating space 31 and each of the two grooves 44, respectively.

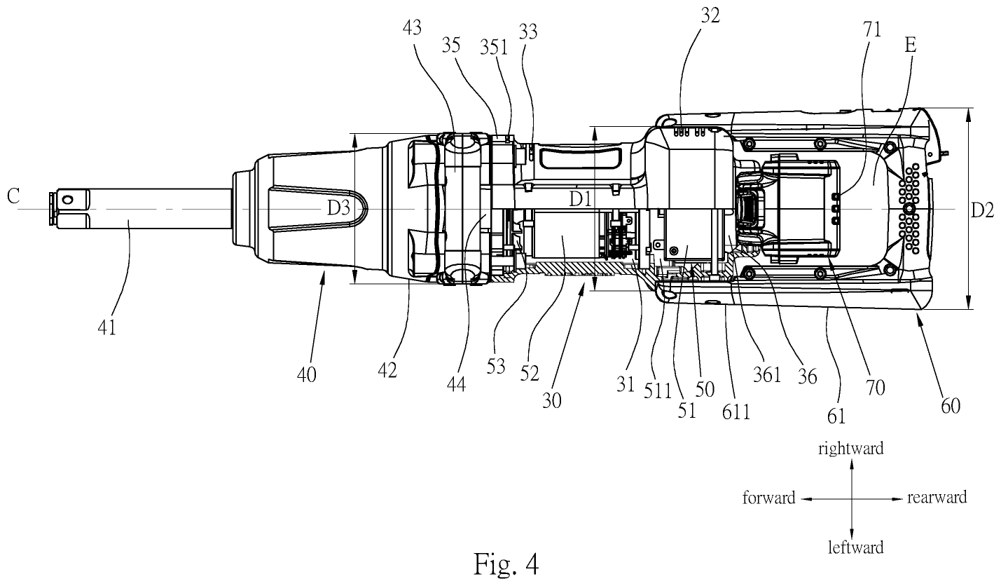

Please refer to FIGS. 4 and 12, the drive assembly 50 includes a circuit unit 51, an electric motor 52, and a fan 53. The drive assembly 50 is linearly disposed between the rear vents 321 and the front vents 33 along the assembly line C of the accommodating space 31. Centers of gravity of the circuit unit 51, the electric motor 52 and the fan 53 are set close to the assembly line C, so that a center of gravity of the drive assembly 50 is close to the assembly line C. The electric motor 52 is capable of driving the fan 53 and the transmission device 46 of the transmission assembly 40 to rotate. For arrangement sequence of the drive assembly 50, please refer to FIG. 4, the circuit unit 51 is located at a rear end of the accommodating space 31, relatively closest to the rear vents 321, a front end of the circuit unit 51 is provided with a heat dissipation fin 511 to assist in heat dissipation; then, in front of the circuit unit 51 is the electric motor 52 and the fan 53 in sequence. The fan 53 is a centrifugal fan and is relatively closest to the front vents 33. When the fan 53 rotates, a negative pressure is generated in the accommodating space 31, so that air flows from the rear end to a front end of the accommodating space 31, the air enters through the rear vents 321, the auxiliary rear vents 342, and the joint vent 361, and flows through the circuit unit 51 and the electric motor 52 of the drive assembly 50, and then discharges through the front vents 33, the connecting vent 351 and the auxiliary front vents 45. If the fan 53 is disposed at a rear section of the accommodating space 31, air enters through the front vents 33, the connecting vent 351 and the auxiliary front vents 45 at the front end, and discharges from the rear vents 321, the auxiliary rear vents 342, and the joint vent 361 at the rear end.

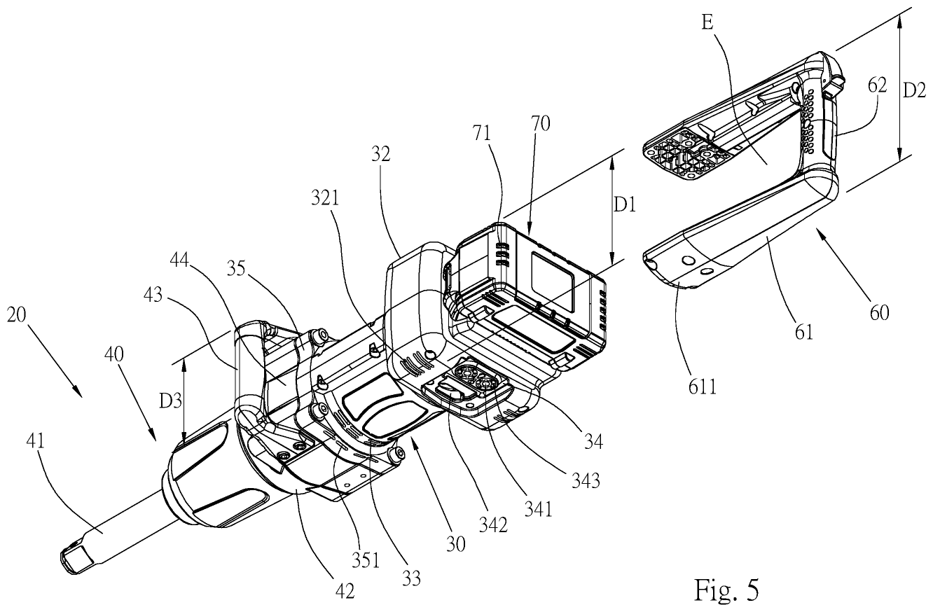

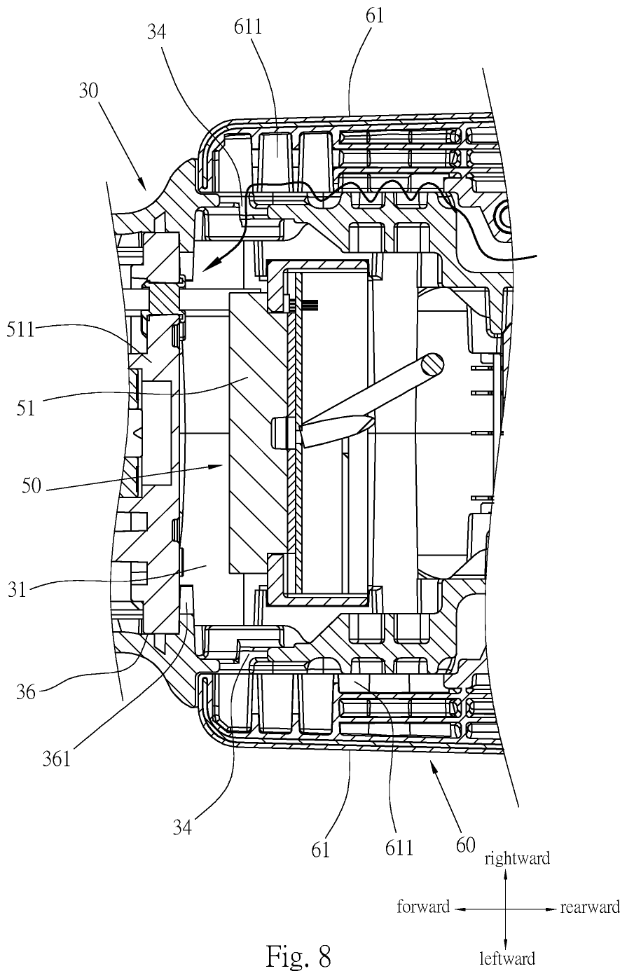

Please refer to FIGS. 5 and 6, the handle 60 has two arms 61 and a holding portion 62. In this embodiment, one end of each of the two arms 61 is disposed at one of two ends of the holding portion 62 respectively, so that the handle 60 forms a left-right symmetrical annular configuration, the handle width D2 is formed between left and right sides of the two arms 61, and a receiving space E is formed between the two arms 61 and the holding portion 62. The receiving space E is located at a central position of the handle 60 so that a center of gravity of the handle 60 can be evenly distributed. The handle 60 is connected at positions of the assembly portions 34 recessed on the assembly section 32 of the rear casing 30. Ends of the two arms 61 are respectively formed with a mating portion 611, and the mating portion 611 is bolted to the screw holes 341 of the assembly portion 34 with bolts. Please refer to FIGS. 2 and 3, a centerline M1 is formed between an upper edge and a lower edge of each of the two arms 61 of the handle 60. When the mating portion 611 is assembled on the assembly portion 34, the centerline M1 will coincide with the central bisector M, that is, located at a center of the electrical tool 20, and a center of gravity of the handle 60 is also set relatively close to the assembly line C. Please refer to FIG. 8, a gap is disposed between the mating portion 611 and the auxiliary rear vent 342, so that air outside the casing 30 is capable of flowing into the accommodating space 31 through the auxiliary rear vents 342. The reinforcing ribs 343 around the screw hole 341 are capable of providing a function of reducing stress concentration, so that it is not easy for the handle 60 to fall off from the rear casing 30, thereby increasing a service life. In addition, in order to simplify an overall configuration and reduce sizes of contour and cross-sectional area of the electrical tool 20, a ratio of the handle width D2 of the handle 60 to the casing maximum width D1 of the assembly section 32 of the rear casing 30 is approximately falls between 1 and 1.5, and a best ratio is between 1.05 and 1.3, so that the handle width D2 of the handle 60 is equivalent to the casing maximum width D1 of the rear casing 30 of the electrical tool 20, and sizes of contour and cross-sectional area of the entire electrical tool 20 will not increase too much, and therefore the electrical tool 20 can be operated or placed and stored away in a relatively narrow place. All the components will be evenly disposed along the central bisector M and above or below the central bisector M, and the electrical tool 20 is disposed uniformly and symmetrically, thereby it is not easy for a center of gravity to deviate and easy for the user to hold and operate. In addition, a height of the front handle 43 is about the same as the handle width D2, so that an overall contour does not protrude outwardly too much, and the front handle 43 is capable of providing an effect of assisting holding.

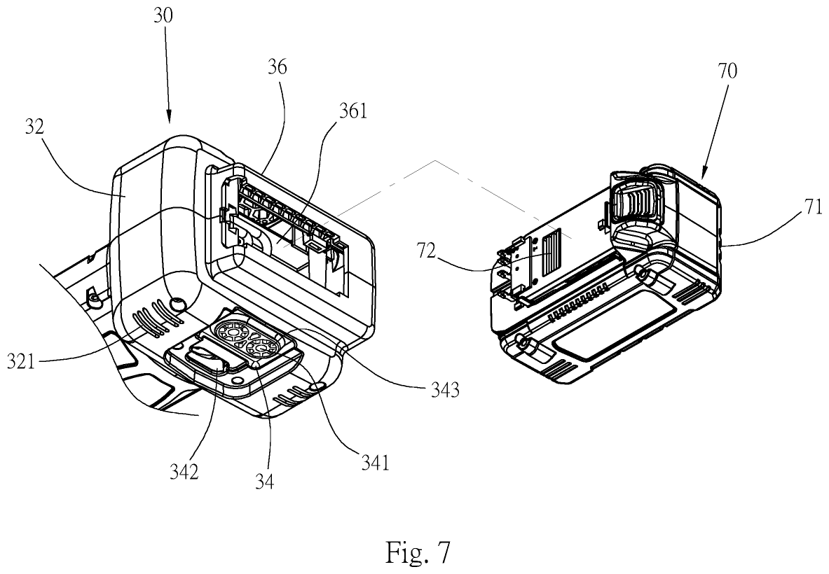

Please refer to FIG. 7 for the battery unit 70, the battery unit 70 is detachably mounted on the joint 36 at the rear end of the rear casing 30, and located at a central position of the receiving space E formed by the two arms 61 and the holding portion 62 of the handle 60, a center of the battery unit 70 is also approximately located on the central bisector M, and a center of gravity of the battery unit 70 is also set close to the assembly line C. The battery unit 70 is electrically connected to the drive assembly 50 to provide the drive assembly 50 with electric power and can be protected by the handle 60 to avoid being separated from the rear casing 30 caused by influence of foreign objects or external forces. A rear side of the battery unit 70 is provided with battery rear vents 71, arrangement positions and opening sizes and shapes of the battery rear vents 71 can be designed to achieve a better fluid flow effect, but it is not limited thereto. A front side of the battery unit 70 is provided with a battery front vent 72, when the battery unit 70 is assembled on the joint 36, the battery front vent 72 communicates with the joint vent 361. When the fan 53 rotates to generate negative pressure drawing from back to front, air will also be drawn into the battery unit 70 from the battery rear vents 71 to dissipate heat, and is discharged through the battery front vent 72, and the air is sucked into the accommodating space 31 through the joint vent 361.

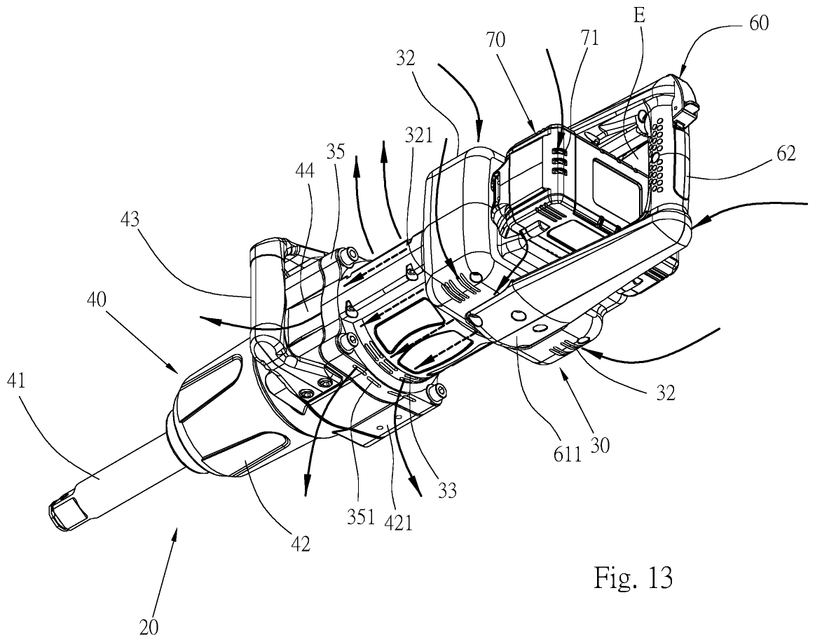

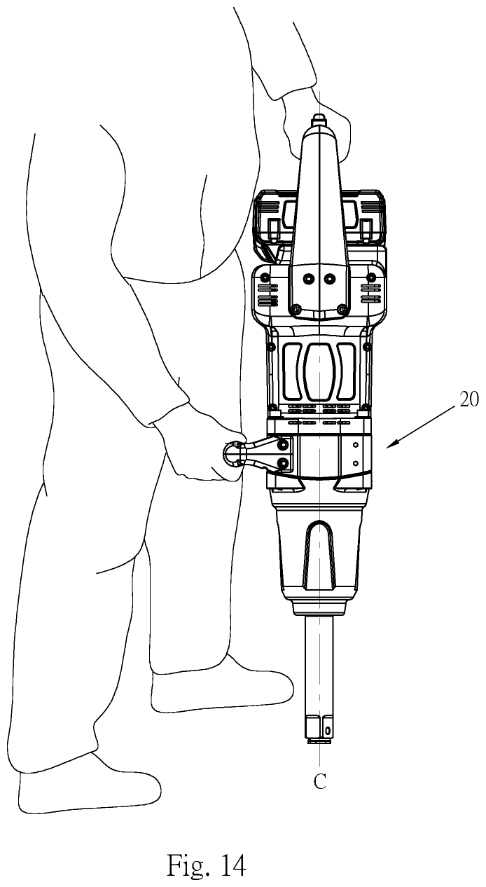

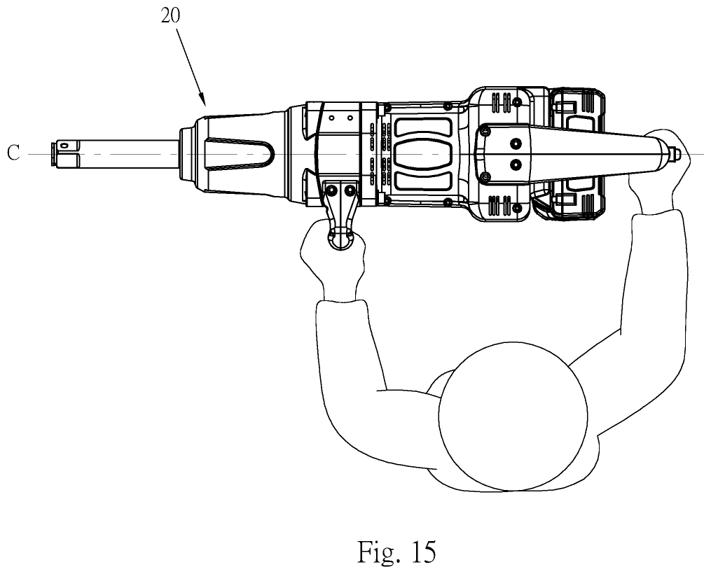

For the electrical tool 20 provided by the invention, please refer to FIGS. 2 and 3 and FIGS. 12 and 13. The casing, the transmission assembly 40, the drive assembly 50, the handle 60 and the battery unit 70 are disposed in a straight line along the assembly line C, and a center of gravity of each of the components is well-designed and a counterweight of each component is well-configured as thoughtfully as possible, so that a center of gravity of each components can coincide with or can be close to the assembly line C, or centers of gravity of different components can be adjusted and matched to make an overall center of gravity position to coincide with or close to the assembly line C. After the electrical tool 20 is assembled, an overall center of gravity will be close to or coincide with the assembly line C, so that the electrical tool 20 is capable of greatly reducing moment of force and lateral acting force caused by deviation of center of gravity. Please refer to FIG. 14, the electrical tool 20 will exert force along the assembly line C during operation. If a center of gravity is close to the assembly line C, when the electrical tool 20 is in operation, a center of gravity does not deviate much from the assembly line C, and relatively no excessive moment of force and lateral acting force will be generated due to excessive arm of force, so that the user can apply force in a direction of the assembly line C to overcome a gravity of the electrical tool 20. There is no need to specifically overcome the influence of lateral acting force during operation process, which can reduce discomfort of operation, and because the electrical tool 20 will not have lateral acting force, force can be applied more accurately during operation process to improve work precision and efficiency. Alternatively as shown in FIG. 15, when the user holds the electrical tool 20 with both hands to apply force laterally, a center of gravity of the electrical tool 20 will be close to a center without generating acting force in front and rear directions relative to the user, which can help the user to hold stably and will not cause discomfort for operating for a long period of time. In addition, in a process of moving the electrical tool 20, because a center of gravity of the electrical tool 20 is close to the assembly line C, the electrical tool 20 will only produce a single directional gravity, which makes it relatively easier for the user to move, and there is no need to overcome a lateral acting force caused by deviation of center of gravity. Furthermore, all the components are arranged along the assembly line C, so that sizes of contour and cross-sectional area of the electrical tool 20 can be reduced, and the handle width D2 and the front handle width D3 are almost the same as the casing maximum width D1, so that the electrical tool 20 can be operated in a relatively narrow space, thereby increasing its scope of application, and when the electrical tool 20 needs to be stored away, the electrical tool 20 can be placed in a small and narrow space to reduce the need for large storage space.

In addition, please refer to FIGS. 2, 3 and 12, 13, because all the components of the electrical tool 20 are disposed in a straight line along the assembly line C, the battery unit 70 and the accommodating space 31 and the drive assembly 50 inside the rear casing 30 are capable of generating air flow in a same direction. When the battery unit 70 drives the drive assembly 50 to actuate, the electric motor 52 will drive the transmission assembly 40 and make the acting shaft 41 actuate. At the same time, the circuit unit 51 and the electric motor 52 generate heat energy during actuation, the fan 53 rotates with the electric motor 52, and at the same time, a negative pressure is formed in the accommodating space 31 and the battery unit 70, so that air is drawn by suction of the negative pressure to flow from the back toward the front, and the air will be sucked into the entire accommodating space 31 through the rear vents 321, the auxiliary rear vents 342, and the joint vent 361. After entering a large-diameter section 311 of the accommodating space 31, the air flows toward a small-diameter section 312, and the air is discharged toward the front vents 33, the connecting vent 351, and the auxiliary front vents 45 at the front end. Due to different cross-sectional areas of the large-diameter section 311 and the small-diameter section 312 of the accommodating space 31, when the air flows from the large-diameter section 311 toward the small-diameter section 312, a flow speed of the air will increase to enhance a heat dissipation effect because a cross-sectional area is reduced. In addition, because the drive assembly 50 is disposed along the assembly line C in a straight line, when an air current flows, it will first flow from a direction of the circuit unit 51 toward a direction of the electric motor 52, and since both the circuit unit 51 and the electric motor 52 are located in a flowing direction of the air current, it can ensure that the circuit unit 51 and the electric motor 52 are ensured to dissipate heat well. In addition, since the circuit unit 51 is disposed at a position of the large-diameter section 311 of the accommodating space 31, a position with a larger area can be provided for arranging the electronic components and the heat dissipation fin 511, which provides better functionality and larger heat dissipation area. Because the air will fill the entire accommodating space 31, the electric motor 52 and the circuit unit 51 of the drive assembly 50 will be covered by the air around the entire circumferences and all-around heat dissipation can be achieved. At the same time, the battery unit 70 will benefit from an effect of negative pressure generated by the fan 53, air is capable of entering through the battery rear vents 71 of the battery, and heat inside the battery unit 70 is guided from the battery front vent 72 to the accommodating space 31, so that the battery unit 70 can also dissipate heat.

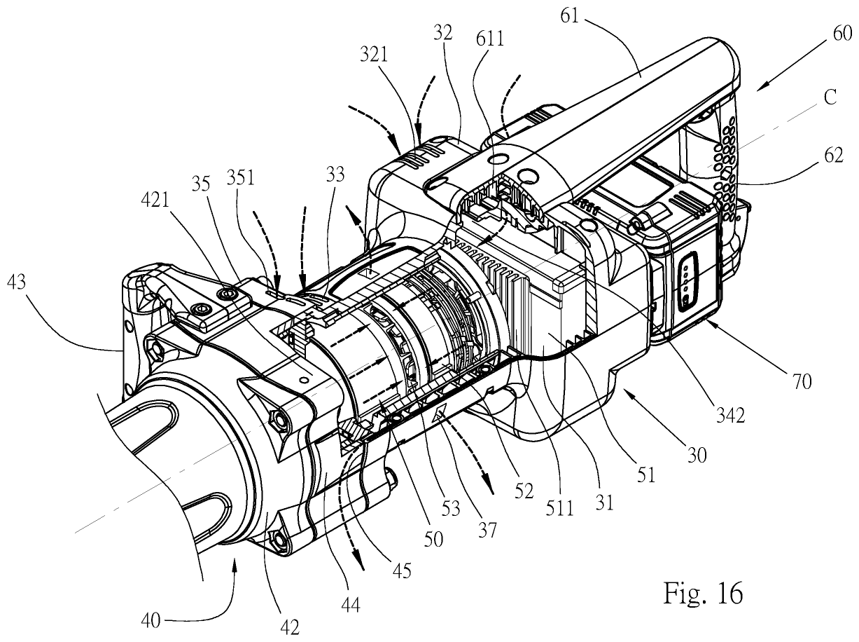

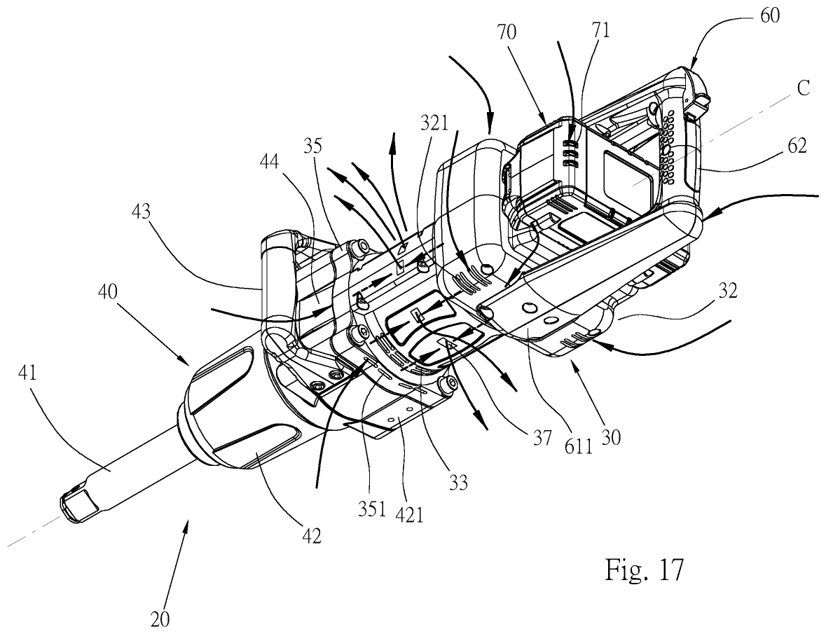

Please refer to FIGS. 16 and 17 for a second preferred embodiment of the invention with main structures the same as that of the previous embodiment. The same components use the same reference numerals and will not be repeated here, wherein:

central positions of the rear casing 30 are surroundingly provided with central vents 37, arrangement position and opening size and shape of the central vent 37 can be designed to achieve a better fluid flow effect, but the arrangement position and opening size and shape are not limited to those shown in the drawings. The fan 53 of the drive assembly 50 is located between the circuit unit 51 and the electric motor 52, so that the fan 53 is relatively close to the central vents 37, such that after the fan 53 is driven by the electric motor 52, negative pressure suction is generated on both sides of the fan 53 to enable air to enter through the rear vents 321, the auxiliary rear vents 342, and the joint vent at the rear end, and enter into the accommodating space 31 through the front vents 33, the connecting vent 351, and the auxiliary front vents 45 at the front end, and to be guided to the central vents 37 at the central positions of the rear casing 30 through the fan 53 and then discharged, so that the electric motor 52 and the circuit unit 51 can be respectively performed with heat dissipation by the air. In addition, the fan 53 can also draw air into the accommodating space 31 from positions of the central vents 37, and the air is respectively guided to the rear vents 321, the auxiliary rear vents 342, and the joint vent 361 at the rear end to be discharged, and then discharged outside of the accommodating space 31 through the front vents 33, the connecting vent 351, and the auxiliary front vents 45 at the front end.

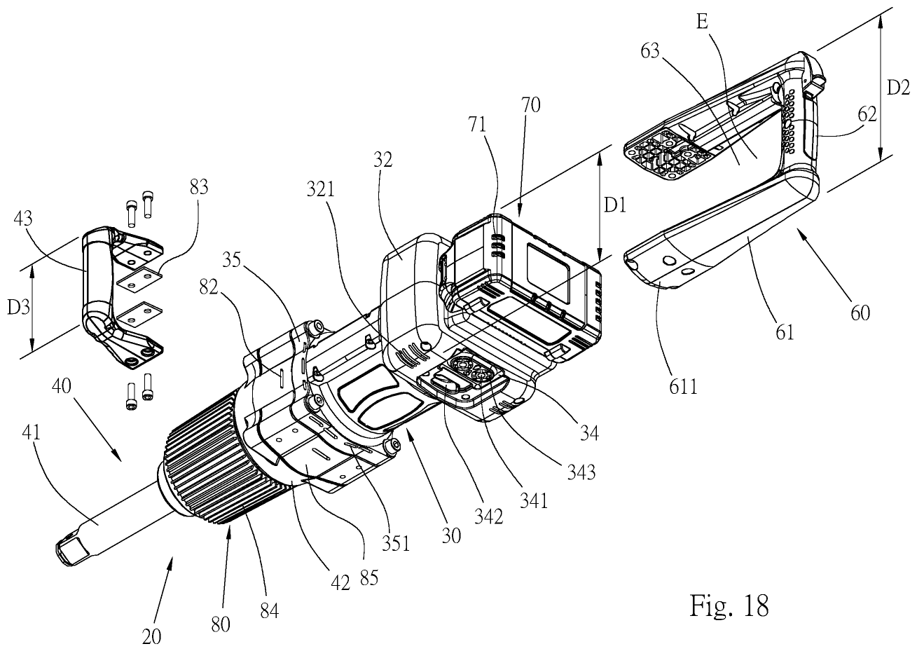

Please refer to FIGS. 18 to 20 for a third preferred embodiment of the invention with main structures the same as that of the previous embodiment. The same components use the same reference numerals and thus will not be repeated here, wherein:

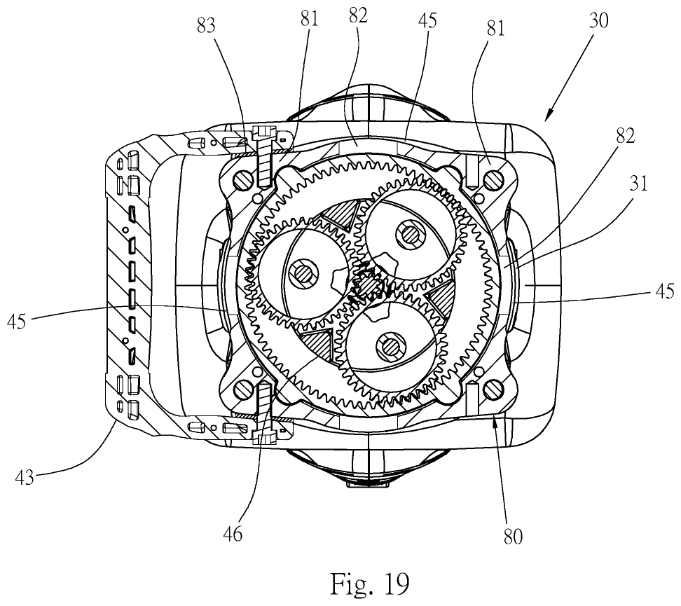

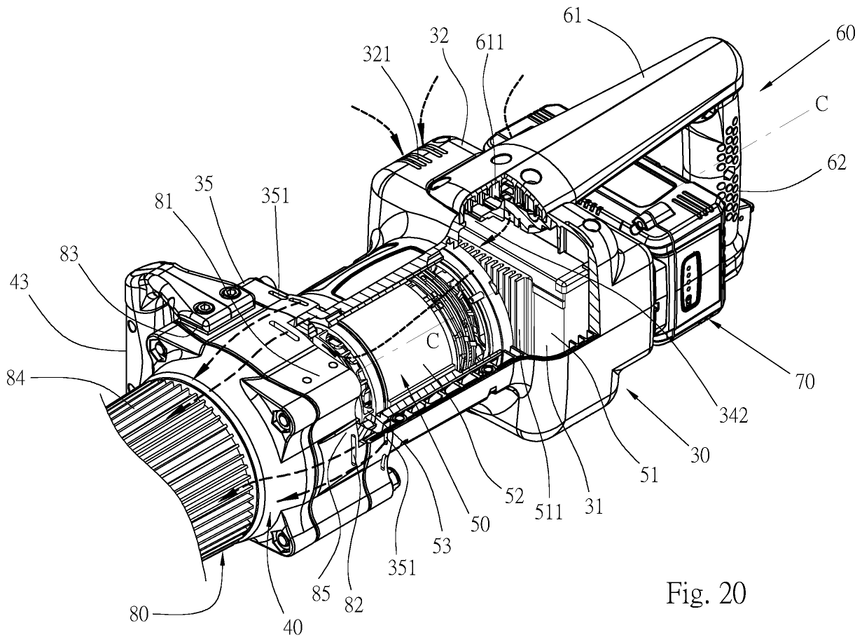

a front casing 80 is sleeved at an outer side of the transmission assembly 40, the transmission assembly 40 is provided with the transmission device 46 and the acting shaft 41 in the front casing 80, the acting shaft 41 is provided at a front end of the transmission assembly 40 and protrudes outside of the front casing 80 and is driven by the transmission device 46; the front casing 80 is respectively formed with a link portion 81 on upper and lower sides respectively; please refer to FIG. 18, the front handle 43 can be selectively assembled on the upper link portion 81 or the lower link portion 81 according to requirements to facilitate holding, using and changing hand by users with different dominant hands, a heat insulation gasket 83 is disposed between two ends of the front handle 43 and the front casing 80 respectively, so that the front handle 43 is capable of blocking heat from the front casing 80; please refer to FIGS. 18 and 19, the front casing 80 is disposed with a plurality of front vents 82 at a rear end, the front vents 82 penetrate a surface of the front casing 80 and are located around the transmission device 46, such that the front vents 82 penetrate into the front casing 80, arrangement positions and opening sizes and shapes of the front vents 82 can be designed to achieve a better fluid flow effect, but the arrangement positions and opening sizes and shapes are not limited to those shown in the drawings; the rear end of the front casing 80 is assembled with the front end of the connecting portion 35 of the rear casing 30, the front casing 80 is recessed with a plurality of grooves 85 opposite to rear end positions, the grooves 85 are inclined from front to back, and outer sides of the grooves 85 of the front casing 80 communicate with the accommodating space 31 through the auxiliary front vents 45; in addition, in order to increase a heat dissipation area of the front casing 80, the front end of the front casing 80 is provided with a heat dissipation portion 84, the heat dissipation portion 84 can be a fin configuration or a concave-convex surface configuration to increase a heat dissipation surface area, moreover, the heat dissipation portion 84 can be disposed adjacent to the front vents 82, so that airflow of the front vents 82 and the auxiliary front vents 45 can flow to reach a periphery of the heat dissipation portion 84, and air can be circulated thoroughly around the heat dissipation portion 84 to improve a heat dissipation effect. Please refer to FIG. 20, the front vents 82 are capable of guiding airflow into the transmission device 46 for heat dissipation, and the auxiliary front vents 45 are capable of guiding airflow into the grooves 85 outside the front casing 80 to form flowing of air current to take away heat energy conducted by the transmission device 46 to the front casing 80, thereby reducing a part of heat energy of the transmission assembly 40.

In the electrical tool of the invention, the casing, the drive assembly, the transmission assembly, the battery unit and the handle are disposed in a straight line along the assembly line, so that a center of gravity of the electrical tool will be close to the assembly line, which is capable of reducing arm of force caused by deviation of center of gravity, thereby the electrical tool can be easily operated and moved, and the handle width is only slightly wider than the casing maximum width, so that the electrical tool has a simplified configuration with small contour and cross-sectional area, and can be operated or stored away in a narrow place. The battery unit can be protected by the handle and is not easy to fall off, and the drive assembly is accommodated in the accommodating space in a straight line along the assembly line, air is guided by air inlets and air outlets at the front and rear ends to provide the circuit unit and the electric motor with excellent and all-around heat dissipation effect in the accommodating space. Compared with the conventional electrical tools with the body and the extension not disposed on a same line and with a larger cross-sectional area, an operating environment is limited and the extension cannot be protected. Moreover, because the components are not assembled and arranged on a same line, heat dissipation effect is not good. While the invention is capable of quickly and thoroughly guiding air to dissipate heat through linear arrangement of the components, thereby effective heat dissipation is enabled for the electric motor and the circuit unit.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. An electrical tool comprising:
an assembly line defined between a front end and a rear end of the electrical tool, and being a straight line;
a casing;
a transmission assembly and a drive assembly disposed inside the casing along the assembly line; the transmission assembly being disposed in front of the drive assembly, the drive assembly being capable of driving the transmission assembly to actuate;
a battery unit disposed at a rear end of the casing along the assembly line, the battery unit being electrically connected with the drive assembly; and
a handle disposed at the rear end of the casing along the assembly line.

2. The electrical tool as claimed in claim 1, wherein a receiving space is formed between the handle and the casing; the battery unit is disposed between the receiving space.

3. The electrical tool as claimed in claim 2, wherein the receiving space is located at a central position of the handle, and shapes of the handle on both sides of the receiving space are symmetrical.

4. The electrical tool as claimed in claim 3, wherein the handle has a holding portion and two arms, two ends of the holding portion are respectively connected with the two arms, so that an annular configuration is formed between the holding portion and the two arms, a receiving space is formed between the holding portion and the two arms; front ends of the two arms are assembled at the rear end of the casing; the battery unit is located inside the receiving space.

5. The electrical tool as claimed in claim 1, wherein the casing has a front casing and a rear casing assembled and disposed in a straight line along the assembly line; the transmission assembly is disposed inside the front casing, the drive assembly is disposed inside the rear casing; an accommodating space is formed inside the rear casing along a direction of the assembly line, the rear casing is provided with at least one air inlet at a rear end and at least one air outlet at a front end, and each of the air inlets and each of the air outlets communicate with the accommodating space.

6. The electrical tool as claimed in claim 1, wherein two sides of the casing form a width of the casing, and a casing maximum width is formed at a position with a largest width of the casing; a handle width is formed between two sides of the handle; a ratio of the handle width to the casing maximum width is between 1 and 1.5.

7. The electrical tool as claimed in claim 6, wherein the casing maximum width is set at the rear end of the casing.

8. The electrical tool as claimed in claim 6, wherein a ratio of the handle width to the casing maximum width is between 1.05 and 1.3.

9. The electrical tool as claimed in claim 1, wherein the rear end of the casing has two assembly portions, and the handle is assembled on the assembly portions.

10. The electrical tool as claimed in claim 9, wherein each of the assembly portions is provided with at least one screw hole and an auxiliary air inlet, two mating portions are provided at two ends of the handle to be screwed on the assembly portions respectively, the auxiliary air inlet communicates with the accommodating space, and a gap is disposed between each of the two mating portions and each of the auxiliary air inlets; a periphery of the screw hole of the assembly portion is convexly provided with reinforcing ribs.

11. The electrical tool as claimed in claim 5, wherein the drive assembly comprises a circuit unit, an electric motor and a fan, the drive assembly is disposed inside the casing and arranged along the assembly line, the drive assembly is located between the air inlet and the air outlet; the circuit unit is close to the air inlet, and the fan is close to the air outlet.

12. The electrical tool as claimed in claim 1, wherein a front handle is provided on an outer side of the casing, and is installed at a front section of the casing, and is located in front of the handle.

13. The electrical tool as claimed in claim 5, wherein the front casing is provided with a front handle; an outer side of the front casing is provided with two link portions, and the front handle is selectively disposed on any one of the link portions.

14. The electrical tool as claimed in claim 12, wherein a weight of the electrical tool with the front handle is greater than 5 kg.

15. The electrical tool as claimed in claim 5, wherein at least one groove is provided at a junction of the front casing and the rear casing, and each of the grooves forms an auxiliary air outlet at a front end of the rear casing.

16. The electrical tool as claimed in claim 5, wherein a rear end of the rear casing is provided with a joint, the joint is provided with a joint vent to communicate with the accommodating space; the battery unit is provided with at least one battery air inlet and a battery air outlet, and the battery air outlet communicates with the joint vent.

17. The electrical tool as claimed in claim 1, wherein the electrical tool defines a central bisector located at a center of the electrical tool, the electrical tool forms an upper half configuration and a lower half configuration at an upper side and a lower side of the central bisector respectively, and the upper half configuration and the lower half configuration are symmetrically disposed at upper and lower sides.

18. The electrical tool as claimed in claim 17, wherein the handle has a centerline located between upper and lower edges of each of the two arms, and the centerline of the handle is located on the central bisector.
